(19) United States
(12) Patent Application Publication
(10) Pub. No.: US 2009/0073348 A1
(43) Pub. Date: Mar. 19, 2009

(54) DISPLAY AND BACKLIGHT MODULE THEREOF

(75) Inventors: Long-Sheng Liao, Hsinchu (TW); Chao-Shun Chen, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: YOUNG OPTICS INC., Hsinchu (TW)

(21) Appl. No.: 12/120,950

(22) Filed: May 15, 2008

(30) Foreign Application Priority Data
Sep. 17, 2007 (TW) 96134698

(51) Int. Cl. G02F 1/13357; G02B 27/18; F21V 7/04

(52) U.S. Cl. 349/67; 349/62; 362/259; 362/553

(57) ABSTRACT

A backlight module for a display includes a light source, a lens unit, a reflective unit and a prism. The light source provides a light beam. The light beam passes through the lens unit to be expanded, then transmits to the reflective unit and reflected to the prism. The light source may be a laser source.

### BACKGROUND OF THE INVENTION

1. Field of the Invention

The invention relates to a backlight module, and more particularly, to a backlight module utilizing decreased number of light sources.

2. Description of the Related Art

FIG. 1a shows a conventional backlight module 1, including a plurality of light sources 10, a light guide 20, a reflector 30, a diffuser 41, a diffuser 42, a prism 50 and a polarizing sheet 60. With reference to FIG. 1b, light sources 10 are light emitting diodes. In a conventional backlight module 1, light beams 11 transmit from the light sources 10, pass through the light guide 20, the reflector 30, the diffuser 41, the diffuser 42, the prism 50 and the polarizing sheet 60, and exit the backlight module 1.

Conventionally, to provide evenly distributed illumination, the amount of required the light sources (light emitting diodes) 10 is large. Additionally, the light beams provided by the light sources are without polarization property. Thus, a polarizing sheet 60 is required, the utilization of the light beams is reduced, and more light sources 10 (light emitting diodes) are required to provide sufficient illumination. Large amounts of required light sources increase the power consumption and the heat of the light module.

### BRIEF SUMMARY OF THE INVENTION

A detailed description is given in the following embodiments with reference to the accompanying drawings.

The invention is to provide a backlight module, which utilizes decreased number of light sources, and provides evenly distributed illumination and increased brightness.

In an embodiment of the invention provides a backlight module for a display, which includes a light source, a lens unit, a reflective unit and a prism. The light source provides a light beam. The light beam passes through the lens unit to be expanded, and then transmits to the reflective unit to be reflected to the prism. The light source is a laser source.

In another embodiment, one embodiment of the invention provides a display including a liquid crystal panel and a backlight module. The backlight module corresponds to the liquid crystal panel, which includes a light source, a lens unit, a reflective unit and a prism. The light source provides a light beam. The light beam passes through the lens unit to be expanded, and then transmits to the reflective unit to be reflected to the prism and directed to the liquid crystal panel.

In one embodiment of the invention, the light beam is uniformly projected to the liquid crystal panel, thus, the light guide is omitted. A polarized light source (laser source) is utilized, thus, the polarizing sheet is omitted. Namely, the embodiment of the invention omits the light guide and polarizing sheet, improves the light utilization providing a sufficient illumination utilizing fewer the light sources, which reduces heat generation. Additionally, by modifying the uniformity element, the lens unit and the reflective unit, the divergent angle of the light beam is controlled, and the thickness of the backlight module is reduced.

Other objectives, features and advantages of the present invention will be further understood from the further technology features disclosed by the embodiments of the present invention wherein there are shown and described preferred embodiments of this invention, simply by way of illustration of modes best suited to carry out the invention.

### BRIEF DESCRIPTION OF THE DRAWINGS

The invention can be more fully understood by reading the subsequent detailed description and examples with references made to the accompanying drawings, wherein:

FIG. 1a is a side view of a conventional backlight module;

FIG. 1b is a top view of a conventional backlight module;

FIG. 2a is a top view of a backlight module of a first embodiment of the invention;

FIG. 2b is a side view of the backlight module of the first embodiment of the invention;

FIG. 3 shows a display of the first embodiment of the invention;

FIG. 4a is a top view of a backlight module of a second embodiment of the invention; and

FIG. 4b is a side view of the backlight module of the second embodiment of the invention.

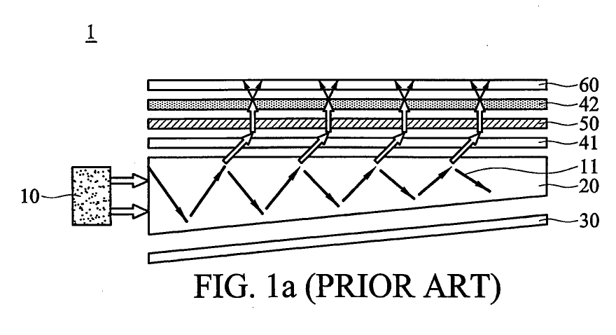

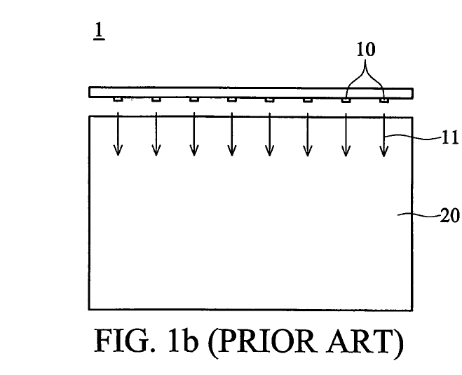

### DETAILED DESCRIPTION OF THE INVENTION

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

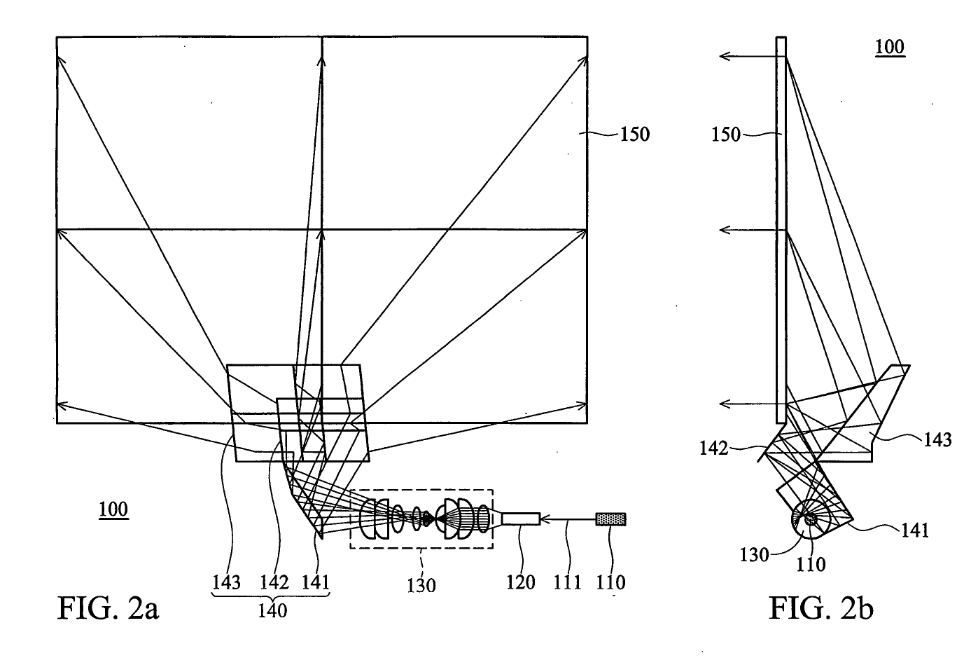

FIGS. 2a and 2b show a backlight module 100 of a first embodiment of the invention, including a light source 110, an uniformity element 120, a lens unit 130, a reflective unit 140 and a prism 150. The light source 110 is a light emitting diode. In a modified embodiment, the light source 110 is a polarized light source providing a polarized light beam. In the first embodiment, the light source 110 is a laser source providing a laser beam. The uniformity element 120 may be a diffraction element, a light pipe or other elements with an uniformity function. The lens unit 130 consists of a plurality of lenses or a single lens. The lens unit 130 is a spherical lens, an aspherical lens or a single mode lens. The reflective unit 140 includes a plane reflector 141, a plane reflector 142 and an aspherical mirror 143.

With reference to FIG. 2a, the light source 110 provides a light beam (laser beam) 111. The light beam 111 is emitted from the light source 110, enters the uniformity element 120 to be uniformized thereby. Then, the light beam 111 transmits from the uniformity element 120 to the lens unit 130, is expanded by the lens unit 130, and is projected to the plane reflector 141. Next, with reference to FIG. 2b, the light beam 111 is reflected by the plane reflector 141, the plane reflector 142, and the aspherical mirror 143 to the prism 150, and guided as a parallel light beam by the prism 150.

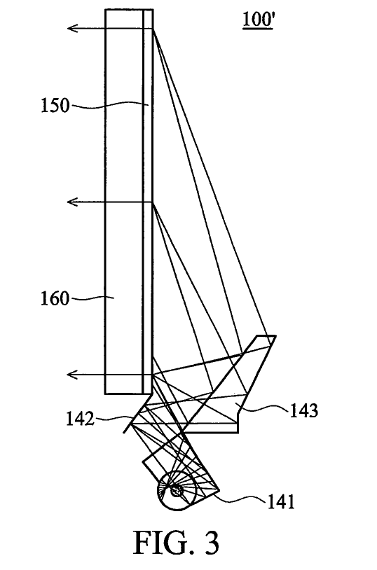

FIG. 3 shows a display 100′ utilizing the backlight module 100 of the first embodiment of the invention. The display 100′ includes a liquid crystal panel 160. The light beam 111 is guided as a parallel light beam by the prism 150, and enters the liquid crystal panel 160.

The light beam 11 is uniformly projected to the liquid crystal panel 160, thus, the light guide is omitted. A polarized light source (laser source) is utilized, thus, the polarizing sheet is omitted. Namely, the embodiment of the invention omits the light guide and polarizing sheet, improves light utilization providing sufficient illumination utilizing fewer light sources, which reduces heat generation. Additionally, by modifying the uniformity element 120, the lens unit 130 and the reflective unit 140, divergent angle of the light beam 111 is controlled, and thickness of the backlight module is reduced.

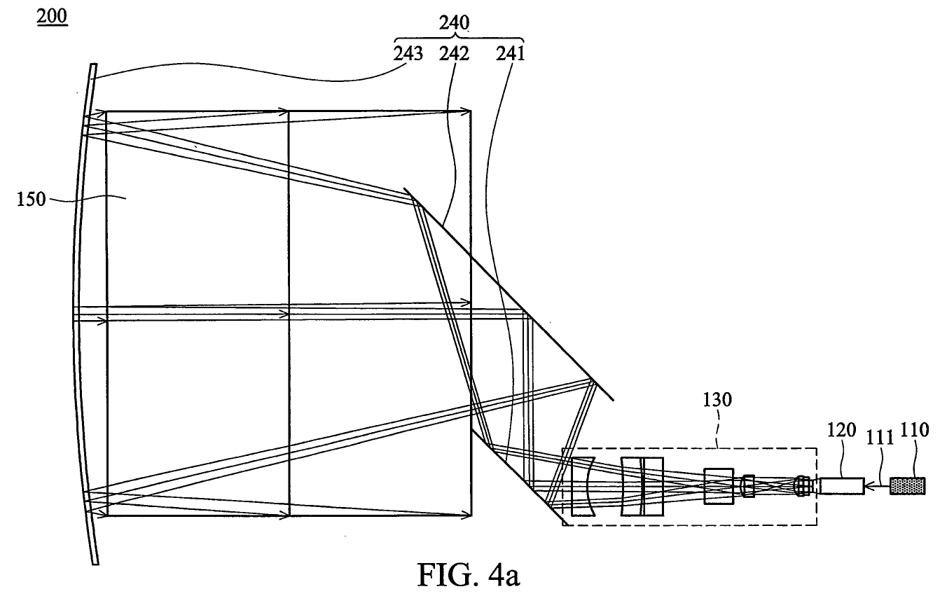

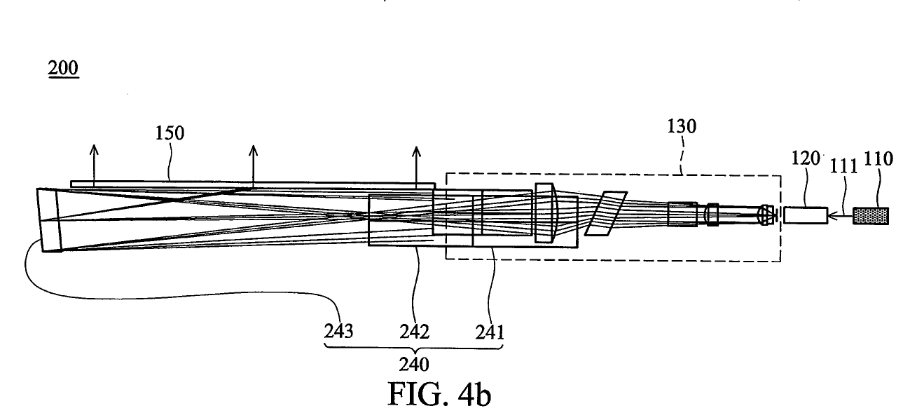

FIGS. 4a and 4b show a backlight module 200 of a second embodiment of the invention, comprising a light source 110, an uniformity element 120, a lens unit 130, a reflective unit 240 and a prism 150. The light source 110 provides a light beam. In a modified embodiment, the light source 110 is a light emitting diode. The uniformity element 120 can be a diffraction element, a light pipe or other elements with an uniformity function. The lens unit 130 can consist of a plurality of lenses or a single lens. The lens unit 130 includes a spherical lens, an aspherical lens or a single mode lens. The reflective unit 440 includes a plane reflector 241, a plane reflector 242 and a biconcave mirror 243.

With reference to FIGS. 4a and 4b, the light source 110 provides the light beam 111. The light beam 111 is emitted from the light source 110 and enters the uniformity element 120 to be uniformized thereby. Then, the light beam 111 transmits from the uniformity element 120 to the lens unit 130, is expanded by the lens unit 130, and is projected to the plane reflector 241. Next, the light beam 111 is reflected by the plane reflector 241, the plane reflector 242 and the biconcave mirror 243 to the prism 150 to be guided as a parallel light beam by the prism 150.

In the embodiments above, the light source may be a laser source or other light sources for providing the light beam. Additionally, the lens unit and the reflective unit are redesigned or replaced. The embodiments mentioned above do not limit the scope of the invention.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A display, comprising:
a liquid crystal panel; and
a backlight module, corresponding to the liquid crystal panel, wherein the backlight module comprises:
a light source, providing a light beam,
a lens unit,
a reflective unit, and
a prism; wherein the light beam passes through the lens unit to be expanded, then transmits to the reflective unit to be reflected to the prism and directed to the liquid crystal panel.

2. The display as claimed in claim 1, wherein the light source comprises a light emitting diode.

3. The display as claimed in claim 1, wherein the light source comprises a polarized light source.

4. The display as claimed in claim 1, wherein the lens unit comprises a spherical lens or an aspherical lens.

5. The display as claimed in claim 1, wherein the lens unit comprises a single mode lens.

6. The display as claimed in claim 1, further comprising an uniformity element, disposed between the light source and the lend unit, wherein the light beam transmits from the light source, passing through the uniformity element, and enters the lens unit.

7. The display as claimed in claim 6, wherein the uniformity element comprises a diffraction element.

8. The display as claimed in claim 6, wherein the uniformity element comprises a light pipe.

9. The display as claimed in claim 1, wherein the reflective unit comprises an aspherical mirror and two plane mirrors.

10. The display as claimed in claim 9, wherein the light beam passes through the lens unit, is reflected by the plane mirrors, and then is reflected to the prism lens by the aspherical mirror.

11. The display as claimed in claim 1, wherein the reflective unit comprises a biconcave mirror and two plane mirrors.

12. The display as claimed in claim 1, wherein the light beam passes through the lens unit, is reflected by the plane mirrors, and then is reflected to the prism lens by the biconcave mirror.

13. A backlight module for a display, comprising:
a laser source, providing a laser beam;
a lens unit;
a reflective unit; and
a prism; wherein the laser beam passes through the lens unit to be expanded, then transmits to the reflective unit and reflected to the prism.

14. The backlight module as claimed in claim 13, wherein the lens unit comprises a spherical lens or an aspherical lens.

15. The backlight module as claimed in claim 13, wherein the lens unit comprises a single mode lens.

16. The backlight module as claimed in claim 13, further comprising an uniformity element, disposed between the laser source and the lens unit, wherein the laser beam transmits from the laser source, passes through the uniformity element, and enters the lens unit.

17. The backlight module as claimed in claim 16, wherein the uniformity element comprises a diffraction element.

18. The backlight module as claimed in claim 16, wherein the uniformity element comprises a light pipe.

19. The backlight module as claimed in claim 13, wherein the reflective unit comprises an aspherical mirror and two plane mirrors.

20. The backlight module as claimed in claim 13, wherein the reflective unit comprises a biconcave mirror and two plane mirrors.
